(19) United States
(12) Patent Application Publication
(10) Pub. No.: US 2014/0123113 A1
(43) Pub. Date: May 1, 2014

(54) SYSTEM AND A METHOD FOR ANALYZING A PIECE OF CODE

(71) Applicants: Prakriya Venkata Ramana Murthy, Bangalore (IN); Dipak Shetty, Bangalore (IN); Kapil Singi, Bangalore (IN)

(72) Inventors: Prakriya Venkata Ramana Murthy, Bangalore (IN); Dipak Shetty, Bangalore (IN); Kapil Singi, Bangalore (IN)

(73) Assignee: Seimens Aktiengesellschaft, Munchen (DE)

(21) Appl. No.: 13/983,505

(22) PCT Filed: Feb. 4, 2011
(86) PCT No.: PCT/EP11/51651

§ 371 Date: Sep. 6, 2013

(51) Int. Cl. G06F 11/36

(52) U.S. Cl. CPC G06F 11/3664; G06F 11/3684
USPC 717/125

(57) ABSTRACT

A system for analyzing a piece of code includes a symbolic state generator adapted to generate symbolic states for statements in the piece of code where exceptions occur. The symbolic state generator is also adapted to provide the symbolic states as inputs to a static analyzer. The system includes a user interface adapted to transfer an exception specifier having an exception causing state to a static analyzer. The static analyzer is adapted to receive the symbolic states from the symbolic state generator and the exception specifier having the exception causing state from the user interface. The static analyzer is adapted to compare the symbolic states with the exception causing states and to provide a output on a basis of the comparison. The exception specifier includes an exception causing state and represents a language run-time exception or a user defined exception.

The present patent document is a §371 nationalization of PCT Application Serial Number PCT/EP2011/051651, filed Feb. 4, 2011, designating the United States, which is hereby incorporated by reference in its entirety.

### BACKGROUND

The present embodiments relate to analyzing a piece of code.

Exceptions are exceptional conditions that may occur during the execution of a piece of code that changes normal flow of execution of the piece of code. To handle such exceptions, certain exception handling techniques are used, where occurrence of each exception moves the execution of the piece of code to a sub-section of the piece of code that includes a combination of exception and a throw statement corresponding to the exception. The execution of the piece of code may be brought into the normal flow of execution of the piece of code out of the sub-section on resolving issues related to the exception.

These exceptions are exceptional, so while developing the piece of code, a software developer tends to overlooks these exceptions. Thus, to verify presence of representations in the piece of code referring to the exceptions, few techniques like fault injection and mutation testing are available. These techniques do not detect throw statements missing with respect to the exceptions. This eventually reduces the robustness of the piece of code.

### SUMMARY AND DESCRIPTION

The present embodiments may obviate one or more of the drawbacks or limitations in the related art. For example, a piece of code is statically tested by recognizing throw statements to increase robustness of the available piece of code.

According to an embodiment, a system for analyzing a piece of code includes a symbolic state generator adapted to generate symbolic states for statements in the piece of code where exceptions occur and to provide the symbolic states as inputs to a static analyzer. The system also includes a user interface adapted to transfer an exception specifier having an exception causing state to a static analyzer. The static analyzer is adapted to receive the symbolic states from the symbolic state generator and the exception specifier having the exception causing state from the user interface and to compare the symbolic states with the exception causing states. The static analyzer is adapted to provide a output on a basis of such comparison. The exception includes an exception causing state and represents a language run-time exception or a user defined exception. This helps to statically analyze the piece of code and to provide the output to a user of the piece of code to modify the piece of code to improve robustness of the piece of code.

According to another embodiment, on comparing, if the comparison results in a match and if the statement relating to the symbolic state is followed by a forbidden operation, and no throw statement is present in the piece of code, then the static analyzer provides the output for a missing throw statement. This helps to specifically identify missing a throw statement, so that the user of the piece of code may modify the piece of code to improve robustness of the piece of code.

According to one embodiment, on comparison, if the comparison results in the match and if the statement relating to the symbolic state is followed by the forbidden operation that causes the user defined exception, and no throw statement is present in the piece of code, then the static analyzer provides the output for a missing throw statement. This helps to specifically identify the missing throw statement only for user defined exception.

According to an exemplary embodiment, on comparison, if the comparison results in the match, and the forbidden operation may cause the language run-time exception, then the static analyzer checks if a catch handler is present in the piece of code corresponding to the symbolic state and provides the output on a basis of the check. This helps to check the presence of catch handlers for language run-time exceptions, which additionally helps to increase the robustness of the piece of code with respect to language run-time exceptions.

According to one embodiment, on comparison, if the comparison results in the mismatch, then the static analyzer is adapted to verify presence of the throw statement. If the throw statement is verified to be present, then the static analyzer is adapted to provide the output on a basis of the verification. Such verification checks for the presence of the throw statement at right places in the piece of code.

According to another embodiment, the system includes a test case generator for generating cases from the piece of code by identifying exception flow paths passing through the throw statement and inter-relation between the flow paths. The exception flow path refers to flow of control passing through the throw statement. Generating test cases to test exceptions further provides a way to improve robustness of the piece of code.

### BRIEF DESCRIPTION OF THE DRAWINGS

The drawings contain the following figures, in which like numbers refers to like parts, throughout the description and drawings.

FIG. 1 illustrates schematic diagram of a system for analyzing a piece of code.

FIG. 2 shows a flow diagram of a method for analyzing a piece of code.

### DETAILED DESCRIPTION

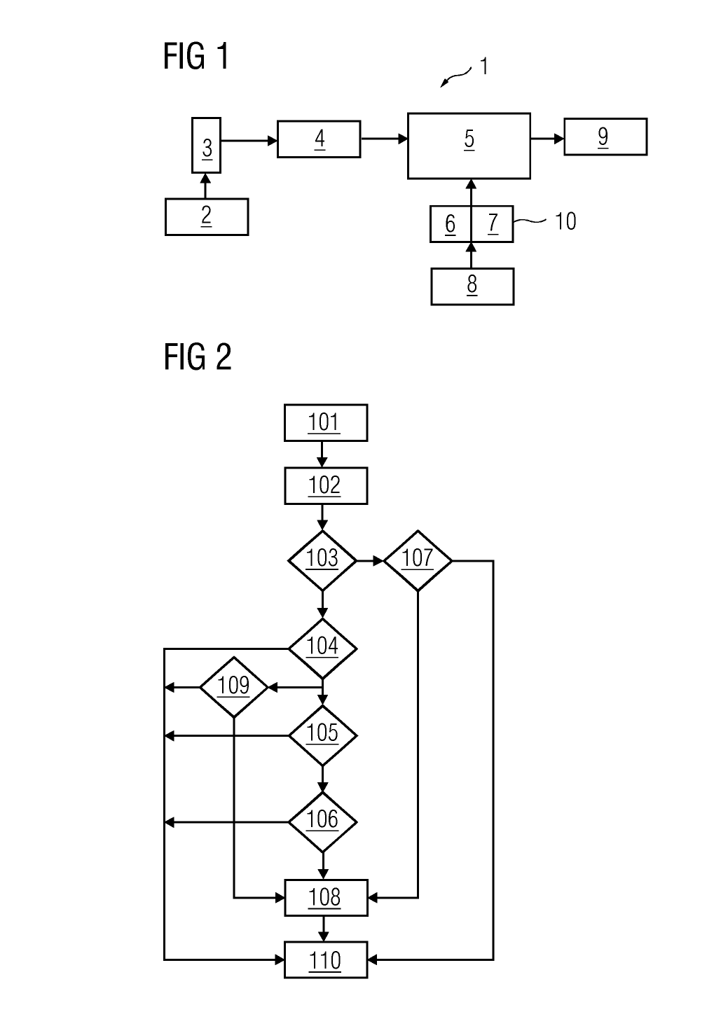

FIG. 1 illustrates one embodiment of a system 1 for analyzing a piece of code 2 using a symbolic state generator 3, a user interface 8 and a static analyzer 5. The symbolic state generator 3, the user interface 8, and the static analyzer 5 together cooperate to analyze the piece of code 2 statically. The symbolic state generator 3 generates symbolic states 4 for statements in the piece of code 2 where exceptions occur and provides the symbolic states 4 as inputs to the static analyzer 5. The user interface 8 transfers an exception specifier 10 having an exception causing state 6 to the static analyzer 5. The static analyzer 5 receives the symbolic states 4 from the symbolic state generator 3 and the exception specifier 10 having the exception causing state 6 from the user interface 8 and compares the symbolic states 4 with the exception causing state 6. The static analyzer 5 provides an output 9 on a basis of the comparison.

The piece of code 2 is a software program that is available for testing by the user. While generating the available piece of code 2, a software developer may have added all the exception handling sub-routines with regard to exceptions mentioned in an exception specifier 10 document.

The exception specifier 10 is a document having a collection of all exceptions that have been developed during a conception and designing phase of the available piece of code 2. In the exception specifier 10, the exceptions may be represented in the following format:

### <Exception Causing State or Property, Forbidden Operation>

To simplify, the above expression provides that by executing the forbidden operation 7 on the available piece of code 2, the execution has moved into exception causing state 6 or property that in furtherance represents occurrence of the exception.

The exception specifier 10 includes two types of exceptions (e.g., language run time exceptions and user-defined exceptions). Examples for representations of both types of exceptions in exception specifier 10 are as follows:

Examples of Language Runtime exceptions are:
DivideByZero: <denominator equals zero, divide>
ArrayOutOfBounds: <(index<array.lowerBound) or (index>array.upperBound), array[index]>

Example of a User-Defined exception (application behavior related) is
<(balance<amount to be withdrawn), // exception causing state Withdraw (amount to be withdrawn)>// forbidden operation in the above state

As these exceptions are very rare to occur, while generating the available piece of code 2, the software developer may forget to add exception handling sub-routines with respect to some or many of these exceptions.

The exception handling sub-routine includes code for identifying occurrence of the rare event followed by the throw statement. The throw statement is only reachable in the available piece of code 2 if the execution of the available piece of code 2 results in occurrence of the rare event. Hence, the set of available test cases are designed such that the occurrence of the rare event becomes certain while executing the available test case onto the available piece of code 2.

The exception handling sub-routine may be represented in the available piece of code 2 as follows:
If (occurrence of rare event is satisfied), then execute the throw statement;

The symbolic state 4 at statement in the piece of code 2 is defined as binding of variables in the piece of code 2 to the values of the the variables. Values are symbolic expressions. If the statement s has member variables v1, v2, v3, . . . vm, and method m at the statement has arguments a1 . . . an, the symbolic state 4 at statement s in method m(a1 . . . an) is <<v1, e1>, . . . , <vm, em>, <a1, Expr1>, . . . , <an, Exprn>> where e1 . . . em are values bound to the variables through assignments reaching statement s, and Expr1 to Exprn are values bound to formal arguments of method m at statement s in method m(a1, . . . , an). If statement s is an assignment to a class member variable v1 as in v1=v2 and v2 is bound to e2 just before reaching statement s, the symbolic value of variable v1 just following the symbolic execution of s is e2, and all other variables are bound to the same expressions as before the symbolic execution of s.

The symbolic state 4 is further illustrated through the following example showing part of the piece of code 2 having a user defined exception related to withdraw operation in a banking system 1. For example, a variable relevant for the statements P1, P2 and P3 is balanced for determining the symbolic state 4 identification. The method relevant for the part of the piece of code 2 is withdraw, and the forbidden operation 7 is withdraw (amount). The relevant part of the piece of code 2 used, for example, is as follows:

/* balance >=0; k>=0; */
...
P1: balance = balance − k;
...
P2: withdraw (amount);
...
/* definition of method withdraw: amount >=0 */
withdraw (int amount)
{
P3: balance = balance − amount;
};

The operation withdraw (amount) may not take place successfully if amount>balance. The static analyzer 5 computes symbolic states 4 of the balance at each program point P1, P2 and P3, as the variables are present in the user-defined exception causing state 6.

Just preceding program point P1, the static analyzer 5 visualizes the symbolic state 4 as (balance>=0) AND (k>=0). Just following P1 and preceding P2, the static analyzer 5 considers the symbolic state 4 as (k>=0), which corresponds to ((balance>0) OR (balance<0) OR (balance==0)) AND (k>=0). Just preceding program point P3, in method withdraw( ), the proposed static analyzer 5 visualizes the symbolic state 4 as (amount>=0) and (k>=0), which corresponds to ((balance>0) OR (balance<0) OR (balance==0)) AND (k>=0) AND (amount>=0). The static analyzer 5 infers the relevant symbolic state 4 with respect to the variable balance as ((balance>0) OR (balance<0) OR (balance==0)) AND (amount>balance).

The output 9 is in relation to identification of missing throw statements, checking presence of catch handlers in case of occurrence of language run-time exceptions, verification of presence of throw statements at appropriate places, or combinations thereof.

On comparing the symbolic states 4 with the exception causing states 6, if the comparison results in a match and if the statement relating to the symbolic state 4 is followed by a forbidden operation 7, and no throw statement is present in the piece of code 2, then the static analyzer 5 provides the output 9 for a missing throw statement. In an exemplary embodiment, the static analyzer 5 outputs for the missing throw statement if the forbidden operation 7 causes the user defined exception.

The static analyzer 5 also checks presence of the catch handler for language run-time exception if, on comparison of the symbolic states 4 with the exception causing states 6, the comparison results in the match, and the forbidden operation 7 may cause the language run-time exception, then the static analyzer 5 checks if a catch handler is present in the piece of code 2 corresponding to the symbolic state 4 and provides the output 9 on a basis of the check.

The static analyzer 5 verifies presence of the throw statement. If, on comparison of the symbolic states 4 with the exception causing states 6, the comparison results in the mismatch, then the static analyzer 5 is adapted to verify presence of the throw statement. If the throw statement is verified to be present, then the output 9 is provided on a basis of the verification.

In an exemplary embodiment, the system 1 also includes a test case generator for generating cases from the piece of code 2 by identifying exception flow paths passing through the throw statement and inter-relation between the flow paths. The exception flow path refers to flow of control passing through the throw statement.

The static analyzer 5, the symbolic state generator 3 and the test case generator may be general purpose computer processing units that are adapted to respectively perform the functions as explained in FIG. 1. In an embodiment, the static analyzer 5, the symbolic state generator 3, the test case generator, or a combination thereof may be a part of one processor as different modules of the processor.

FIG. 2 illustrates a flow chart for one embodiment of a method for analyzing the piece of code statically to identify missing throw statements, to check presence of catch handlers in case of occurrence of language run-time exceptions, and to verify presence of throw statements at appropriate places.

In act 101, a symbolic state generator receives a piece of code and generates symbolic states for statements in the piece of code where exceptions occur and to provide the symbolic states as inputs to a static analyzer. In act 102, a static analyzer receives the symbolic states and exception causing states via a user interface. In act 103, the static analyzer compares the symbolic states and the exception causing states. On basis of such comparison, the static analyzer provides an output in act 108. After providing the output in act 108, the method for analyzing the piece of code ends at act 110.

The output represents identification of missing throw statement, identification of presence of catch handlers, or verification of presence of missing throw statements.

In act 103, if the comparison results in a match, then in act 104, whether the statement relating to the symbolic state is followed by a forbidden operation is identified. In act 109, the static analyzer then checks for absence of a throw statement in the piece of code. The static analyzer then provides the output for a missing throw statement in act 108. In an exemplary embodiment, the output for the missing throw statement is provided by the static analyzer only if the forbidden operation is one that causes the user defined exception. In act 104, if the static analyzer is not able to identify that the statement relating to the symbolic state is followed by the forbidden operation, then the method for analyzing the piece of code ends at act 110. In act 109, if the static analyzer checks to find the throw statement to be present, then the method for analyzing the piece of code ends at act 110.

In act 103, if the comparison results in a match, then in act 104, whether the statement relating to the symbolic state is followed by a forbidden operation is identified. In step 105, whether the forbidden operation causes the language run time exception is identified on identifying the statement in act 104. On identifying the forbidden operations in act 105, the static analyzer checks if a catch handler is present in the piece of code corresponding to the symbolic state in act 106 and provides the output on a basis of the check in act 108. In act 104, if the static analyzer is not able to identify that the statement relating to the symbolic state is followed by the forbidden operation, then the method for analyzing the piece of code ends at act 110. In act 105, if the static analyzer does not identify the forbidden operation causing the language run time exception, then the method for analyzing the piece of code ends at act 110.

In act 103, if the comparison results in a mismatch, then in act 107, the static analyzer verifies presence of the throw statement. If the throw statement is verified to be present, then the static analyzer provides the output on a basis of the verification in act 108. In act 107, if the static analyzer does not verify presence of the throw statement, then the method for analyzing the piece of code ends at act 110.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for analyzing a piece of code, the system comprising:
a first computer processor configured to implement a symbolic state generator configured to:
generate symbolic states for statements in the piece of code where exceptions occur; and
provide the symbolic states as inputs to a static analyzer; and
a user interface configured to transfer an exception specifier having an exception causing state to the static analyzer,
wherein the static analyzer is configured to receive the symbolic states from the symbolic state generator and the exception specifier having the exception causing state from the user interface, is configured to compare the symbolic states with the exception causing states, and is configured to provide an output on a basis of the comparison, and
wherein the exception specifier represents a language run-time exception or a user defined exception.

2. The system according to claim 1, wherein when the comparison results in a match and when the statement relating to the symbolic state is followed by a forbidden operation and no throw statement is present in the piece of code, the static analyzer is configured to provide the output for a missing throw statement.

3. The system according to claim 2, wherein when the comparison results in the match and when the statement relating to the symbolic state is followed by the forbidden operation, which causes the user defined exception, and no throw statement is present in the piece of code, the static analyzer is configured to provide the output for the missing throw statement.

4. The system according to claims 1, wherein when the comparison results in the match and the forbidden operation is adapted to cause the language run-time exception, the static analyzer the static analyzer is configured to check when a catch handler is present in the piece of code corresponding to the symbolic state and provide the output on a basis of the check.

5. The system according to claim 1, wherein when the comparison results in a mismatch, the static analyzer is configured to verify presence of a throw statement, and when the throw statement is verified to be present, the static analyzer is configured to provide the output on a basis of the verification.

6. The system according to claim 1, further comprising a second computer processor configured to implement a test case generator configured to generate test cases from the piece of code, the generation comprising identification of exception flow paths passing through a throw statement and inter-relation between the exception flow paths,
wherein the exception flow path refers to flow of control passing through the throw statement.

7. A method for analyzing a piece of code comprising:
generating, with a processor, symbolic states for statements in the piece of code where exceptions occur and providing the symbolic states has inputs to a static analyzer using a symbolic state generator;
transferring an exception specifier having an exception causing state to the static analyzer via a user interface;
receiving the symbolic states from the symbolic state generator and the exception specifier having the exception causing state from the user interface by the static analyzer; and
comparing, with the static analyzer, the symbolic states with the exception causing states and providing an output on a basis of the comparison by the static analyzer,
wherein the exception specifier represents a language run-time exception or a user defined exception.

8. The method according to claim 7, further comprising providing, with the static analyzer, the output for a missing throw statement when the comparison results in a match and when the statement relating to the symbolic state is followed by a forbidden operation and no throw statement is present in the piece of code.

9. The method according to claim 8, further comprising providing, with the static analyzer, the output for the missing throw statement when the comparison results in the match and when the statement relating to the symbolic state is followed by the forbidden operation that causes the user defined exception, and no throw statement is present in the piece of code.

10. The method according to the claim 7, further comprising checking, with the static analyzer, when a catch handler is present in the piece of code corresponding to the symbolic state and providing the output on a basis of the check when the comparison results in the match and a forbidden operation is adapted to cause the language run-time exception.

11. The method according to the claim 7, further comprising verifying, with the static analyzer, presence of the throw statement when comparison results in the mismatch, and providing the output on a basis of the verification when the throw statement is verified to be present.

12. The method according to claim 7, further comprising generating test cases from the piece of code, the generating comprising identifying exception flow paths passing through the throw statement and inter-relation between the flow paths using a test case generator,
wherein the exception flow path refers to flow of control passing through the throw statement.
